(19) United States
(12) Patent Application Publication
(10) Pub. No.: US 2002/0144561 A1
(43) Pub. Date: Oct. 10, 2002

(54) Actuator having guide-equipped frame and method for producing the same

(75) Inventors: Shigekazu Nagai, Adachi-ku (JP); Akio Saitoh, Kawaguchi-shi (JP); Masaru Saitoh, Tsukuba-gun (JP)

Correspondence Address: PAUL A. GUSS, PAUL A. GUSS ATTORNEY AT LAW, 775 S 23RD ST FIRST FLOOR SUITE 2, ARLINGTON, VA, 22202

(73) Assignee: SMC Kabushiki Kaisha, Tokyo (JP)

(21) Appl. No.: 10/108,901

(22) Filed: Mar. 29, 2002

(30) Foreign Application Priority Data
Apr. 6, 2001 (JP) 2001-108192

(51) Int. Cl. F16C 29/00; F16H 25/20

(52) U.S. Cl. 74/89.33; 74/89.23

(57) ABSTRACT

Pressed shape steel forms a frame and long grooves. Guide rails are hardened. Thereafter, outer surfaces of the guide rails are ground. The hardened guide rails are integrally joined into the long grooves of the frame. Ball-rolling grooves are formed on the guide rails. Thus, a guide-equipped frame of an actuator is completed.

### BACKGROUND OF THE INVENTION

1. Field of the Invention

The present invention relates to an actuator comprising a guide-equipped frame having guide grooves formed on the frame. The present invention also relates to a method for producing the same.

2. Description of the Related Art

Various actuators are conventionally used to transport or position a workpiece. Japanese Laid-Open Utility Model Publication No. 2-12554, for example, discloses an actuator having a guide-integrated frame which has guide grooves integrally formed on inner wall surfaces.

The actuator comprises the guide-integrated frame having ball-rolling grooves (guide grooves) axially extending on the inner wall surfaces on both opposed sides. The guide-integrated frame has a ball screw shaft which extends substantially in parallel to the ball-rolling grooves. Further, the guide-integrated frame has a slider. The slider reciprocates along the ball-rolling grooves under the screwing action with the ball screw shaft.

A method for producing the conventional guide-integrated frame will be briefly explained. A pillar-shaped member is drawn to form a drawn product. Warpage of the drawn product is straightened. Next, cutting machining is performed to outer surfaces thereof which cannot be straightened. The straightening is performed again.

Next, the hardening such as the vacuum hardening or the high frequency hardening is performed. Thereafter, the straightening and the polishing of the outer surface are performed. A groove-polishing is also performed to form the ball-rolling grooves on the inner wall surfaces by using a disk-shaped grinding wheel and so on. Thus, the guide-integrated frame is completed.

However, a large number of treatment steps are required in the method for producing the conventional guide-integrated frame. Therefore, the production cost is high. Further, it is impossible to improve the production efficiency because an extremely long period of time is required to polish the outer surface.

### SUMMARY OF THE INVENTION

A general object of the present invention is to provide an actuator having a guide-equipped frame which reduces the production cost by simplifying the production steps to conveniently produce the actuator.

A principal object of the present invention is to provide an actuator having a guide-equipped frame which improves the production efficiency by simplifying the production steps to conveniently produce the actuator.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view illustrating an actuator according to an embodiment of the present invention;

FIG. 2 is an exploded perspective view illustrating the actuator shown in FIG. 1;

FIG. 3 is a partial exploded perspective view illustrating the actuator shown in FIG. 1;

FIGS. 4A to 4G illustrate steps for producing a guide-equipped frame respectively;

FIG. 5 is a perspective view illustrating the amount of flexion when a load is applied with one end of the guide-equipped frame being fixed;

FIG. 6 shows characteristics illustrating the relationship between the load and the strain for a heated frame and a non-heated frame;

FIG. 7 is a vertical sectional view illustrating a guide-equipped frame according to a first modified embodiment;

FIG. 8 is a vertical sectional view illustrating a guide-equipped frame according to a second modified embodiment;

FIG. 9 is a vertical sectional view illustrating a guide-equipped frame according to a third modified embodiment; and

FIG. 10 is a vertical sectional view illustrating a guide-equipped frame according to a fourth modified embodiment.

### DESCRIPTION OF THE PREFERRED EMBODIMENTS

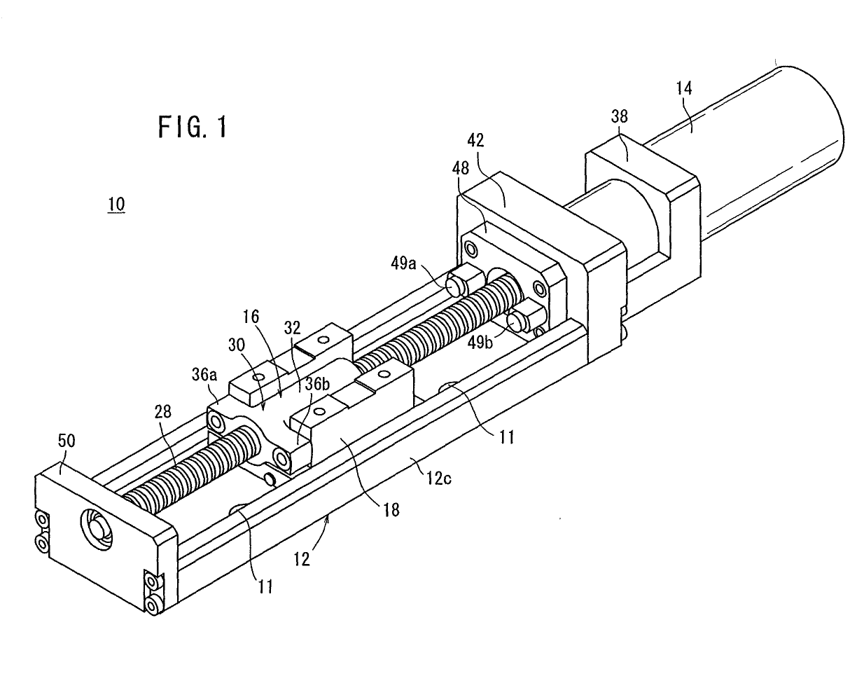

In FIG. 1, reference numeral 10 indicates an actuator according to an embodiment of the present invention.

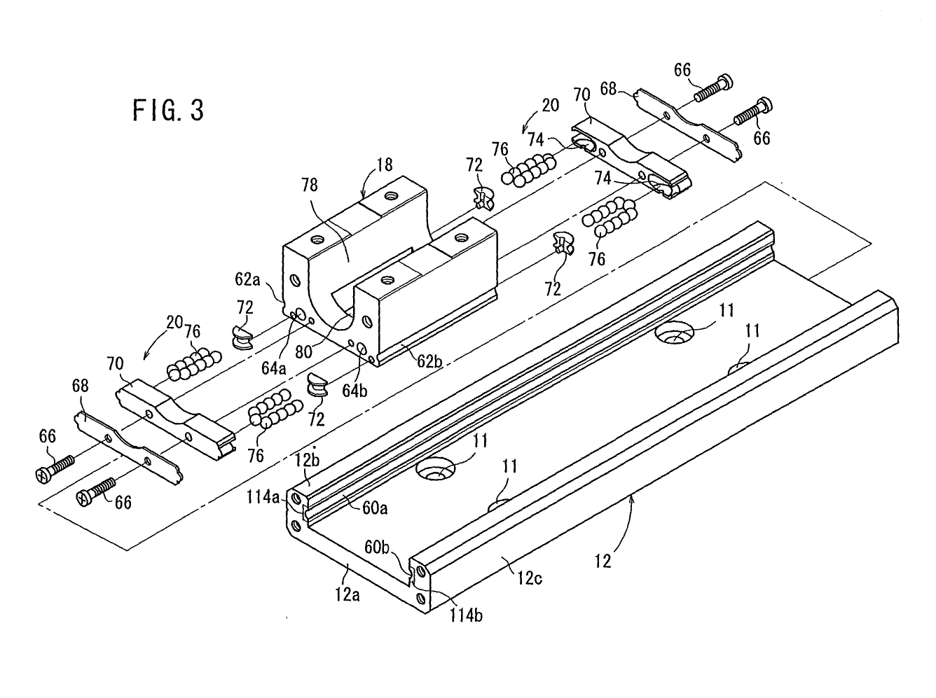

The actuator 10 comprises a guide-equipped frame 12, a rotary driving source 14, a feed screw shaft mechanism 16, a slider 18 and a guide mechanism 20 (see FIG. 3).

The guide-equipped frame 12 has a recess including a plurality of attachment holes 11. The rotary driving source 14 is connected to one end of the guide-equipped frame 12. The feed screw shaft mechanism 16 is a unit detachable with respect to the guide-equipped frame 12. The feed screw shaft mechanism 16 transmits the rotary driving force of the rotary driving source 14 by the aid of an unillustrated coupling member. The slider 18 is reciprocated in the axial direction of the guide-equipped frame 12 by the driving force transmitted by the feed screw shaft mechanism 16. The guide mechanism 20 (see FIG. 3) guides the slider 18 along the guide-equipped frame 12.

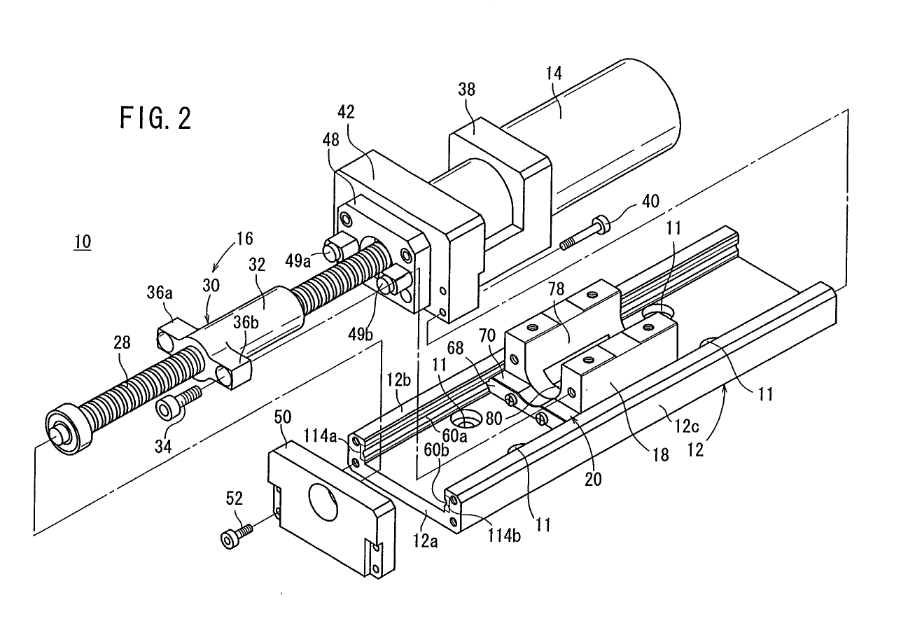

As shown in FIGS. 2 and 3, the guide-equipped frame 12 comprises a bottom 12a of a flat plate shape and a pair of sides 12b, 12c. The pair of sides 12b, 12c are substantially perpendicular to the bottom 12a. The pair of sides 12b, 12c are integrally formed so that they may face one another.

As shown in FIG. 2, the feed screw shaft mechanism 16 includes a ball screw shaft (feed screw shaft) 28 coaxially coupled to the drive shaft of the rotary driving source 14 by the unillustrated coupling member, and a ball screw nut (feed screw nut) 30 having a penetrating screw hole for the ball screw shaft 28 to be screwed therein.

The ball screw nut 30 includes a cylindrical section 32 and a pair of flanges 36a, 36b. The cylindrical section 32 has the penetrating screw hole. The pair of flanges 36a, 36b are integral with one end of the cylindrical section 32 and are fixed to side surfaces of the slider 18 by screws 34.

The feed screw shaft mechanism 16 includes a housing 42, an unillustrated bearing mechanism and a bearing-holding member 48.

The housing 42 has a support section 38 for supporting the rotary driving source 14 and is connected to one end of the guide-equipped frame 12 by screws 40. The unillustrated bearing mechanism is connected to one end of the ball screw shaft 28. The bearing-holding member 48 is connected to the housing 42 by screws. A pair of dampers 49a, 49b are disposed on the bearing-holding member 48. The pair of dampers 49a, 49b are substantially horizontally spaced from each other by a predetermined distance and protrude toward the slider 18 on the bearing-holding member 48.

An end plate 50 is installed by screws 52 to the other axial end of the guide-equipped frame 12. The end plate 50 rotatably supports one end of the ball screw shaft 28.

As shown in FIG. 3, the guide mechanism 20 includes a pair of opposed first ball-rolling grooves 60a, 60b, a pair of second ball-rolling grooves 62a, 62b and a pair of ball-rolling holes 64a, 64b.

The pair of opposed first ball-rolling grooves 60a, 60b extend in the axial direction of the guide-equipped frame 12 on the inner walls of the both sides 12b, 12c of the guide-equipped frame 12. Each of the pair of opposed first ball-rolling grooves 60a, 60b has a vertical cross section of a circular arc shape. The pair of second ball-rolling grooves 62a, 62b are formed on the side surfaces of the slider 18 facing the inner walls of the guide-equipped frame 12. Each of the pair of second ball-rolling grooves 62a, 62b has a vertical cross section of a circular arc shape. The pair of ball-rolling holes 64a, 64b are disposed near the second ball-rolling grooves 62a, 62b and penetrate axially through the slider 18.

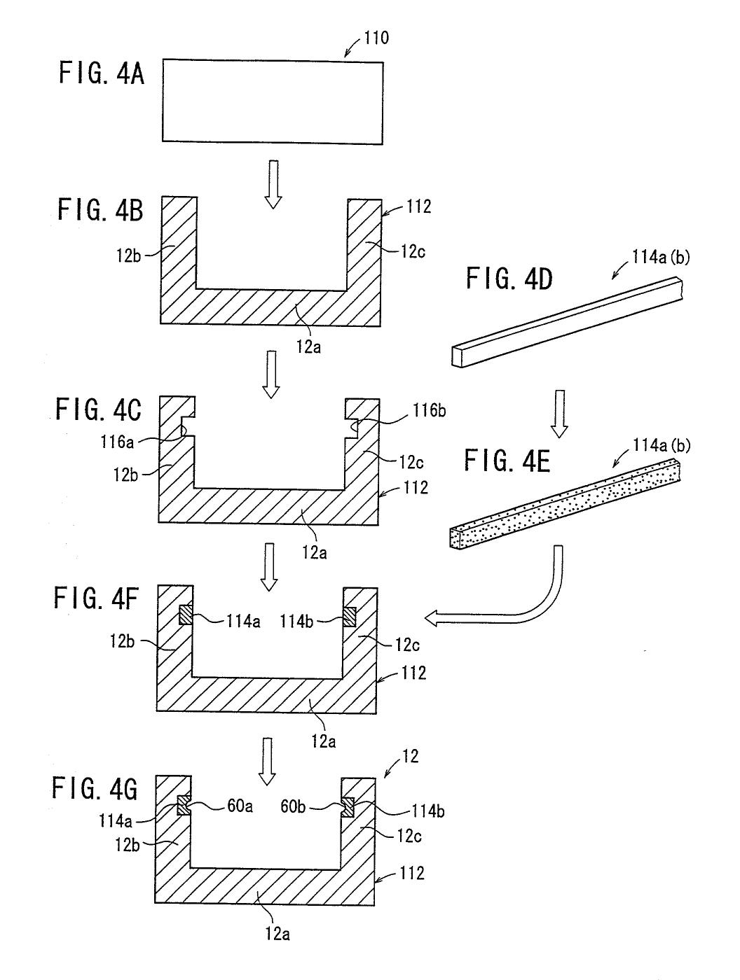

Long grooves 116a, 116b (see FIG. 4C) are formed on the inner walls of the both sides 12b, 12c of the guide-equipped frame 12. The long grooves 116a, 116b extend axially. A pair of guide rails 114a, 114b having the first ball-rolling grooves 60a, 60b are secured to the long grooves 116a, 116b (see FIG. 4G).

The guide mechanism 20 includes plates 68 and covers 70, and return guides 72. The plates 68 and the covers 70 are integrally connected to lower portions of the slider 18 by screws 66. The plates 68 and the covers 70 are substantially parallel to the flanges 36a, 36b of the ball screw nut 30. The return guides 72 are installed to the side surfaces of the slider 18. The plate 68, the cover 70, and the return guide 72 are preferably formed of a resin material.

The plate 68 and the cover 70 are installed to the lower side surface of the slider 18. In other words, the plate 68 and the cover 70 are not installed to the upper side surface of the slider 18. Therefore, the upper side surface thereof can be used as an abutment surface for enabling each of the dampers 49a, 49b to abut.

Components of the plate 68, the cover 70 and the return guides 72 are the same on one and the other axial side surfaces of the slider 18.

Ball return grooves 74 are formed on the cover 70. Endless circulating tracks are constituted by the mutually opposed first and second ball-rolling grooves 60a, 60b, 62a, 62b, the penetrating ball-rolling holes 64a, 64b formed through the slider 18, and the ball return grooves 74. The endless circulating tracks enable a plurality of balls 76 to roll.

As shown in FIGS. 2 and 3, an opening 78 having a U-shaped cross section is formed at an upper center of the slider 18. The opening 78 extends axially. The opening 78 is of a large recess shape which is open upwardly. The cylindrical section 32 of the ball screw nut 30 is installed detachably upwardly.

As shown in FIGS. 2 and 3, a hole 80 is formed through the slider 18. The hole 80 penetrates from the opening 78 downwardly through the slider 18. The hole 80 has a rectangular cross section. Return tubes (not shown) are accommodated in the hole 80. The return tubes are installed to the ball screw nut 30 and serves as passages for enabling the plurality of balls 76 to roll. Therefore, the hole 80 for accommodating the return tubes reduces the height of the slider 18.

The actuator 10 according to the embodiment of the present invention is basically thus constructed. Operation, function, and effect thereof will be explained below.

First, steps for producing the guide-equipped frame 12 of the actuator 10 will be explained.

A flat plate-shaped shape steel 110 composed of stainless steel, aluminum, or aluminum alloy and so on is pressed to form the frame 112 (see FIGS. 4A and 4B) comprising the bottom 12a and the both sides 12b, 12c which are integrally formed. The pressed frame 112 is straightened. Thereafter, cutting machining is roughly performed. Cutting machining is further performed to form the long grooves 116a, 116b which are substantially in parallel to the axis of the frame 112 (see FIG. 4C). The guide rails 114a, 114b are inserted into the long grooves 116a, 116b described later on.

The prism-shaped guide rails 114a, 114b are hardened by a step different from the step performed for the shape steel 110. Each of the prism-shaped guide rails 114a, 114b is formed of a material capable of being hardened. Next, the outer surfaces of the guide rails 114a, 114b are ground (see FIGS. 4D and 4E).

The guide rails 114a, 114b are inserted into and coupled integrally to the long grooves 116a, 116b of the frame 112 (see FIG. 4F). The guide rails 114a, 114b are polished to form the ball-rolling grooves (guide grooves) 60a, 60b. Thus, the guide-equipped frame 12 is completed (see FIG. 4G).

Adhesion, forcible insertion fitting, welding fusion and so on may be available to connect the guide rails 114a, 114b into the long grooves 116a, 116b of the frame 112.

In the method for producing the guide-equipped frame 12, the main frame body is not hardened. The guide rails 114a, 114b having the ball-rolling grooves 60a, 60b are solely hardened. The frame 112 tends to be thermally deformed by the hardening. However, it is not necessary to straighten the frame 112 and to polish the outer surface of the frame 112. Therefore, the production steps can be simple to reduce the production cost.

The main frame body is conventionally hardened (heated). Therefore, it is necessary to perform the straightening and the polishing of the outer surface after performing the hardening. According to the production method of the present invention, the cutting machining is solely performed to the pressed main frame body. Therefore, it is possible to greatly reduce the cost and to improve the production efficiency.

An extremely long period of time is conventionally required to polish the outer surface of the main frame body. According to the present invention, however, the cutting machining may be performed by using a milling cutter and so on. Therefore, the machining time can be greatly reduced.

The surface or the interior of the main frame body is conventionally heated to be hardened. If the outer surface of the main frame body is further machined to form the attachment hole and the attachment groove, it is necessary to use a cemented carbide bit and so on capable of cutting the hardened material. The production cost increases for purchasing the cemented carbide bit and so on. By contrast, the frame 112 is not heated in the production method of the present invention. Therefore, the additional machining can be conveniently performed for the unillustrated attachment hole and so on by the usual cutting machining and so on.

A metal material which can be hardened is conventionally used for the frame. Therefore, the purchase cost thereof is expensive. The frame 112 of the present invention does not require the expensive metal material which can be hardened. Therefore, the cost of purchasing the material of the frame 112 is low, making it possible to decrease the material cost.

In the production method of the present invention, the guide rails 114a, 114b are solely heated without heating the frame 112 for the following reason.

In the guide-equipped frame 12 comprising the bottom 12a and the both sides 12b, 12c which are integrally constructed, it is sufficient that the portions having the first ball-rolling grooves 60a, 60b for enabling the plurality of balls 76 to roll may be solely heated, e.g., hardened for increasing the surface hardness of the above portions.

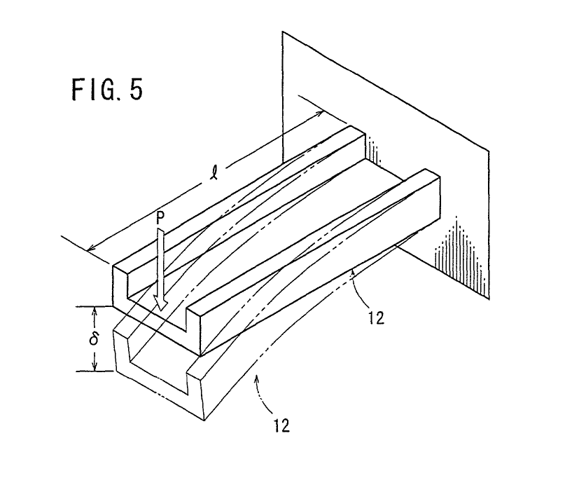

For example, it is assumed that a load (P) is applied substantially vertically downwardly to the guide-equipped frame 12 with one end of the guide-equipped frame 12 being fixed as shown in FIG. 5. The load (P) generates flexion (δ) of the guide-equipped frame 12. The amount of flexion (δ) is identical with respect to the heated frame and the non-heated frame.

Specifically, the amount of flexion (δ) is calculated by the following expression (1) in which the Young's modulus (E) is constant. The amount of flexion (δ) generated by the load (P) is identical for the heated frame and the non-heated frame.

δ=Pl³/3EI (1)

wherein P represents the load, l represents the length, E represents the Young's modulus, I represents the second moment of area, and δ represents the amount of flexion.

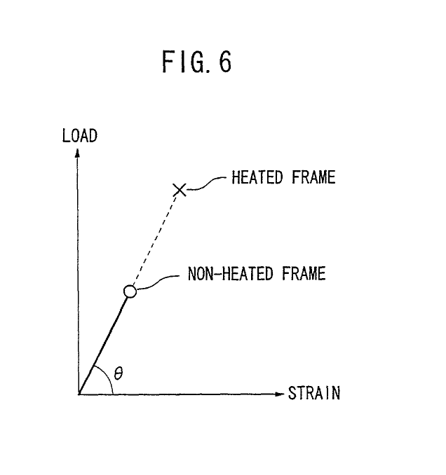

The hardened frame extends the elastic limit and is tough as shown in FIG. 6. However, the amount of flexion (δ) generated by the identical load (P) is identical with respect to the hardened frame and non-heated frame. The slope θ is the same as the Young's modulus (E).

In the actuator 10 of the present invention, therefore, the rigidity of the guide-equipped frame 12 which is not heated can be the same as that of the heated frame.

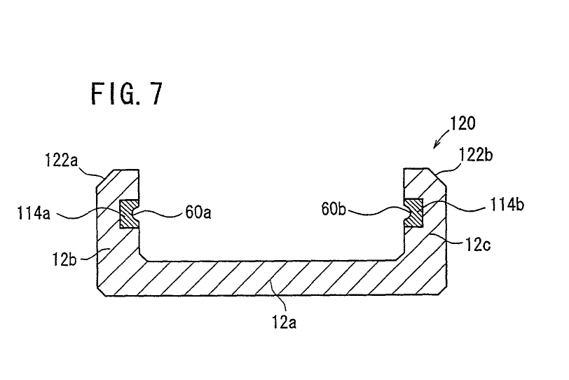

First to fourth modified embodiments of the guide-equipped frame 12 produced by the above production method are shown in FIGS. 7 to 10.

As shown in FIG. 7, a guide-equipped frame 120 according to the first modified embodiment has a pair of guide rails 114a, 114b facing one another on the inner wall surfaces of the sides 12b, 12c of the guide-equipped frame 120. Preferably, the upper surfaces of the sides 12b, 12c are partially cut out and inclined surfaces 122a, 122b inclined by a predetermined angle extend axially.

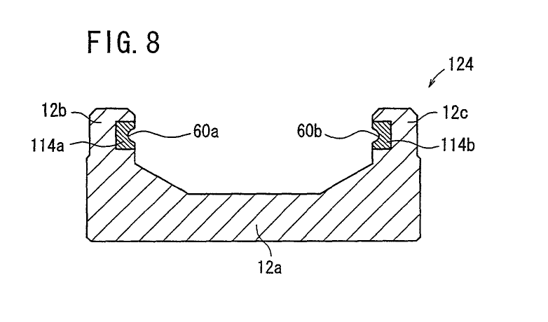

As shown in FIG. 8, in a guide-equipped frame 124 according to the second modified embodiment, connecting portions between the bottom 12a and the both sides 12b, 12c are thicker than the central portion of the bottom 12a.

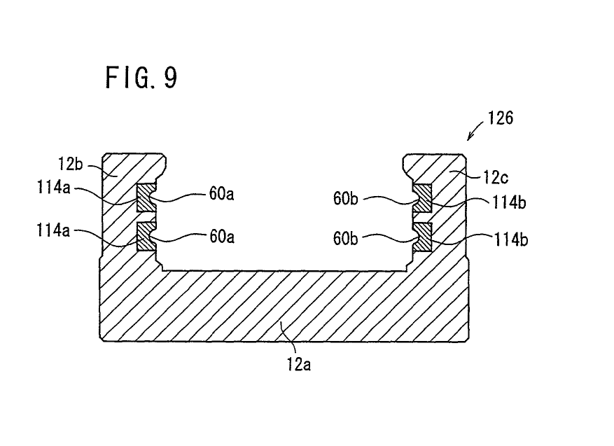

As shown in FIG. 9, in a guide-equipped frame 126 according to the third modified embodiment, two strips of guide rails 114a, 114b are disposed on the inner wall surface of both of the sides 12b, 12c. The two strips of guide rails 114a, 114b face the other two strips of guide rails 114a, 114b.

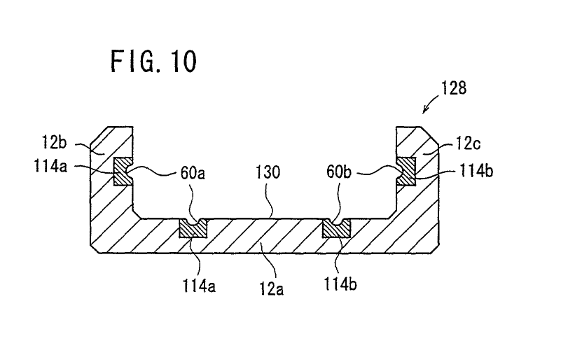

As shown in FIG. 10, a guide-equipped frame 128 according to the fourth modified embodiment has a pair of mutually opposed guide rails 114a, 114b formed on the inner wall surfaces of the both sides 12b, 12c, and a pair of guide rails 114a, 114b substantially in parallel to one another on the bottom surface 130 of the recess of the guide-equipped frame 12.

A method for assembling the actuator 10 will be explained.

The pairs of plates 68 and covers 70 are installed to both of the end surfaces of the slider 18 by the screws 66. The slider 18 is assembled into the recess of the guide-equipped frame 12 (see FIG. 3). The plates 68, the covers 70 and the return guides 72, which are composed of the same components, are installed to one and the other axial ends of the slider 18. Therefore, the plate 68, the cover 70 and so on can be installed from any direction to one and the other ends of the slider 18 in the actuator 10.

In other words, it is possible to conveniently assemble the same components to one and the other axial ends of the slider 18 without considering the installing direction. Further, the components of the guide mechanism 20 can be standardized to make it possible to reduce the number thereof and to decrease the production cost.

As shown in FIG. 2, next, the cylindrical section 32 of the ball screw nut 30 is inserted along the opening 78 upwardly from the slider 18. The flanges 36a, 36b are fastened to the side surface of the slider 18 by the screws 34. The feed screw shaft mechanism 16, to which the ball screw shaft 28, the ball screw nut 30, the end plate 50 and the housing 42 are integrally assembled, is installed to the guide-equipped frame 12.

The slider 18 is not an obstacle member because the opening 78 having a cross section of a U shape is formed at the upper surface of the slider 18. The unit of the feed screw shaft mechanism 16, to which the ball screw shaft 28, the ball screw nut 30, the end plate 50, and the housing 42 are integrally assembled, can be conveniently installed to the guide-equipped frame 12 upwardly from the slider 18. Inversely, the unit of the feed screw shaft mechanism 16 can be conveniently disengaged from the guide-equipped frame 12 through the opening 78 of the slider.

Operation of the actuator 10 will be explained.

An energized unillustrated power source transmits the rotary driving force of the rotary driving source 14 to the ball screw shaft 28. The rotated ball screw shaft 28 is screwed in the screw hole of the ball screw nut 30. The slider 18 connected to the ball screw nut 30 is integrally displaced in the axial direction of the guide-equipped frame 12 by the guide of the guide mechanism 20. When the polarity of the current flowing through the rotary driving source 14 is inverted by an unillustrated controller, the slider 18 can reciprocate in the axial direction of the guide-equipped frame 12.

While the slider 18 reciprocates in the axial direction of the guide-equipped frame 12, the plurality of balls 76 roll along the first ball-rolling grooves 60a, 60b and the second ball-rolling grooves 62a, 62b.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. An actuator comprising:
a guide-equipped frame;
a driving source mounted on said guide-equipped frame;
a feed screw shaft mechanism including a feed screw shaft and a feed screw nut, for transmitting a driving force of said driving source;
a slider having an opening and being reciprocated in an axial direction of said guide-equipped frame by said driving force transmitted by said feed screw shaft mechanism, said opening enabling said feed screw shaft and said feed screw nut to be inserted therein; and
a guide mechanism guiding said slider displaced along said guide-equipped frame,
wherein said guide-equipped frame has long grooves extending axially for guide rails having guide grooves to be installed therein.

2. The actuator according to claim 1, wherein said guide rails are solely hardened.

3. The actuator according to claim 1, wherein said guide mechanism comprises plates and covers which are connected to said slider and return guides which are installed to side surfaces of said slider, and components of said plate, said cover and said return guides are the same on one and the other axial side surfaces of said slider.

4. The actuator according to claim 1, wherein a pair of said guide rails facing one another are disposed on inner wall surfaces of both sides of said guide-equipped frame.

5. The actuator according to claim 4, wherein connecting portions between a bottom and both of said sides of said guide-equipped frame are thicker than a central portion of said bottom.

6. The actuator according to claim 1, wherein a plurality of pairs of said guide rails facing one another are disposed on inner wall surfaces of both sides of said guide-equipped frame.

7. The actuator according to claim 1, wherein a pair of said guide rails facing one another are disposed on inner wall surfaces of both sides of said guide-equipped frame, and another pair of said guide rails parallel to one another are disposed on an inner bottom surface of said guide-equipped frame.

8. A method for producing an actuator having a guide-equipped frame, comprising the steps of:
pressing a shape-forming material to thereby form a frame and long grooves axially parallel on said frame, while hardening guide rails and thereafter grinding outer surfaces of said guide rails; and
integrally joining said guide rails into said long grooves of said frame and thereafter forming guide grooves on said guide rails.

9. The method according to claim 8, wherein said guide grooves are ball-rolling grooves for enabling a plurality of balls to roll therein.
